(19) United States
(12) Patent Application Publication
(10) Pub. No.: US 2024/0191733 A1
(43) Pub. Date: Jun. 13, 2024

(54) Securing Element and Cover for an Interior Mirror Base of a Motor Vehicle

(71) Applicant: Bayerische Motoren Werke Aktiengesellschaft, Muenchen (DE)

(72) Inventors: Stefanus STAHL, Holzkirchen (DE); Martin FRIEDRICH, Muenchen (DE)

(21) Appl. No.: 18/286,585

(22) PCT Filed: Jul. 8, 2022
(86) PCT No.: PCT/EP2022/069040

§ 371 Date: Oct. 12, 2023

(30) Foreign Application Priority Data
Jul. 20, 2021 (DE) 10 2021 118 656.0

(51) Int. Cl. F16B 2/22; B60R 1/04

(52) U.S. Cl. CPC F16B 2/22; B60R 1/04

(57) ABSTRACT

A securing element for a motor vehicle has a hermetic body made of plastic which encloses a cavity. The cavity is filled with a filling medium. The thermal expansion coefficient of the filling medium is, up to a softening temperature of the plastic, greater than the thermal expansion coefficient of the plastic. A cover for an interior mirror base of a motor vehicle includes such a securing element.

### BACKGROUND AND SUMMARY

The present invention relates to a securing element for a motor vehicle, and to a cover for an interior mirror base of a motor vehicle having such a securing element.

Securing elements, such as hooks for attaching a first component to a second component, are known from the prior art. The hook is fixed to a first of the components and hooked to the second component. The hooking causes tensile stresses in the hook. Therefore, when the hook heats up, plastic elongation of the hook occurs as soon as the softening temperature of the material of the hook is reached or exceeded. The plastic elongation of the hook loosens the attachment of the first component to the second component, with the result that the reliability of the attachment falls and noises such as creaking and/or rattling occur.

The object of the present invention is to provide a securing element which ensures a secure attachment of a first component to a second component even in the case of temperature variation without the occurrence of unpleasant noises such as creaking and/or rattling.

This object is achieved by the securing element and by a cover for an interior mirror base of a motor vehicle having such a securing element, in accordance with the features of the independent claims.

Provision is thus made according to the invention of a securing element for a motor vehicle for attaching a first component to a second component and comprising a hermetic body made of plastic. The body encloses a cavity. The cavity contains a filling medium. In connection with the present invention, a “hermetic body” is understood to mean an absolutely tight body, in particular a body that prevents the filling medium from escaping. The coefficient of thermal expansion and therefore the thermal expansion of the filling medium, at least up to a softening temperature of the plastic of the body, is greater than the coefficient of thermal expansion, and the thermal expansion, of the plastic. In connection with the present invention, “softening temperature” should be understood to mean the temperature from which the plastic of the body undergoes plastic and therefore permanent deformation. The softening temperature may also be a temperature range.

The core concept of the invention is thus that the hermetic body is provided with a filling medium that changes its volume to a more pronounced extent, i.e. expands or shrinks to a more pronounced extent, than the plastic of the body when the temperature changes. When the securing element cools, the filling medium thus shrinks to a more pronounced extent than the body, as a result of which a reduced pressure arises in the cavity and the securing element is brought into a prestressed position.

In an advantageous embodiment of the securing element according to the invention, the plastic from which the body is formed is a polyamide.

The polyamide is for example a polyamide 11 (PA11).

In an exemplary embodiment of the securing element according to the invention, the securing element is additively manufactured.

The filling medium comprises for example at least one gas, at least one liquid, and/or at least one solid.

The solid may be a powder.

The gas is for example air.

In a preferred embodiment of the securing element according to the invention, the filling medium comprises at least one gas and at least one solid in powder form.

The proportion by volume of the gas in the total volume of the filling medium is for example 60 to 70 percent by volume.

In an exemplary embodiment, the securing element according to the invention comprises a powder.

The body may comprise the powder in completely remelted form.

The body may be formed from the powder in completely remelted form.

The filling medium comprises the powder for example in powder form and/or partially remelted form. The powder in the filling medium results in acoustic damping of the securing element.

In a preferred embodiment of the securing element according to the invention, the powder is remelted or partially remelted by way of powder bed fusion.

The powder may be remelted or partially remelted by use of multi-jet fusion, by use of selective laser sintering, by use of selective laser melting or by use of electron beam melting.

The body may be produced by resin-based or filament-based additive manufacturing processes.

For example, at least one partition wall is provided in the cavity for the defined control of a deformation of the body when the temperature changes.

The partition wall divides the cavity for example into subchambers.

The subchambers are for example hermetically sealed or connected to one another.

It is also possible to provide a plurality of partition walls which form a kind of labyrinth.

At least one connecting web may also be arranged in the cavity for the defined control of a deformation of the body when the temperature changes, which connecting web connects walls delimiting the cavity to one another, a wall delimiting the cavity to a partition wall or partition walls to one another.

In a preferred embodiment of the securing element according to the invention, the securing element is a mounting hook, in particular a snap-action hook.

Furthermore, the present invention relates to an interior lining of an exterior mirror of a motor vehicle which comprises a securing element described above.

The invention will be explained in more detail below on the basis of exemplary embodiments illustrated in the drawings.

### BRIEF DESCRIPTION OF THE DRAWINGS

FIG. 1 is a sectional view of a first securing element according to an embodiment of the invention;

FIG. 2 is a sectional view of a second securing element according to an embodiment of the invention;

FIG. 3 is a sectional view of a third securing element according to an embodiment of the invention;

FIG. 4 is a sectional view of a fourth securing element according to an embodiment of the invention; and

FIG. 5 is a sectional view of a fifth securing element according to an embodiment of the invention.

### DETAILED DESCRIPTION OF THE DRAWINGS

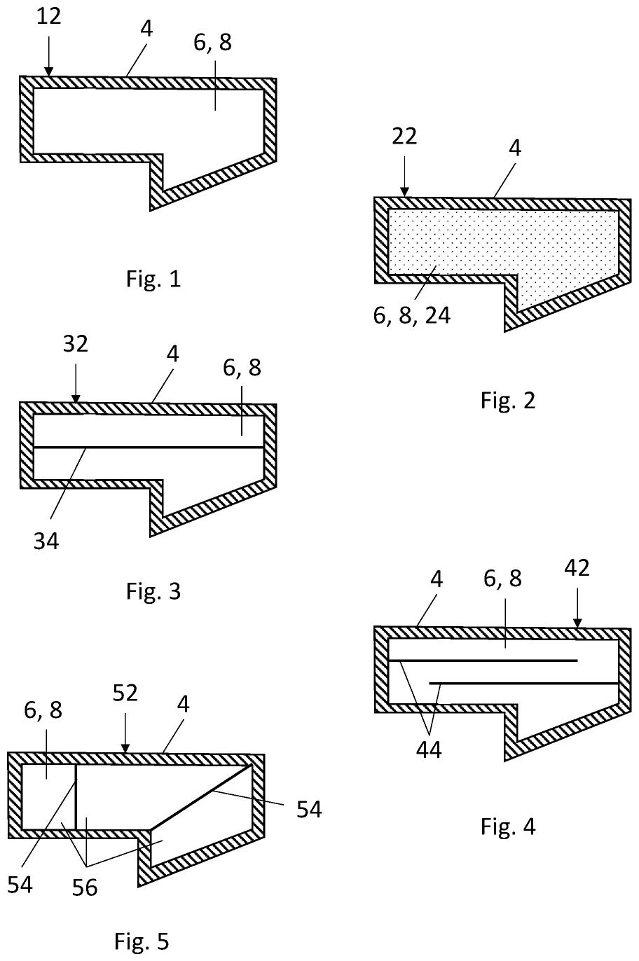

FIG. 1 shows a first securing element 12 according to an embodiment of the invention. The first securing element 12 comprises a hermetic (hollow) body 4 made of plastic and a cavity 6.

The first securing element 12 is in the form of a hook and has been produced from a powder by means of an additive manufacturing process.

The cavity 6 of the first securing element 12 is filled with a filling medium. The filling medium is a gas 8. The gas 8, at least up to a softening temperature of the plastic from which the body 4 is formed, has a higher coefficient of thermal expansion than the plastic.

When the first securing element 12 heats up, the gas 8 in the cavity therefore expands to a more pronounced extent than the plastic of the body 4. Likewise, when the first securing element 12 cools, the gas 8 in the cavity 6 contracts to a more pronounced extent than the plastic of the body 4. Therefore, when the temperature increases up to the softening temperature, the body 4 undergoes elastic deformation, which then resets in the case of cooling, assisted by a reduced pressure in the cavity 6. The body 4 thus returns to its initial configuration or starting position.

FIG. 2 shows a second securing element 22. The second securing element 22 differs from the first securing element 12 shown in FIG. 1 only by the filling medium provided in the cavity 6. The explanations that follow are consequently restricted to a description of the filling medium. Reference is made to the above description of the first securing element 12 with regard to the further configuration of the second securing element 22.

The second securing element 22 contains a filling medium comprising a gas 8 and a powder 24. The powder 24 is the same powder from which the body 4 has been produced. The powder 24 provides vibration-damping properties.

FIGS. 3, 4 and 5 show a third securing element 32, a fourth securing element 42 and a fifth securing element 52 according to the invention, respectively.

With the exception of the features described below, the third securing element 32, the fourth securing element 42 and the fifth securing element 52 correspond to the securing element 12 shown in FIG. 1, for which reason reference is made to the above description of the first securing element 12 with regard to the further configuration of the third securing element 32, of the fourth securing element 42 and of the fifth securing element 52.

The third securing element 32 comprises a connecting web 34 which connects two opposite side walls delimiting the cavity 6.

The fourth securing element 42 and the fifth securing element 52 each comprise two partition walls 44 and 54, respectively.

The partition walls 44 of the fourth securing element 42 form a kind of labyrinth which forms an air channel for the gas 8 contained in the cavity 6.

The cavity 6 of the fifth securing element 52 is divided into subchambers 56 by means of the partition walls 54.

The connecting web 34, the partition walls 44 and the partition walls 54 each enable a controlled thermal expansion and consequently a controlled (elastic) deformation of the third securing element 32, of the fourth securing element 42 and of the fifth securing element 52.

### LIST OF REFERENCE SIGNS

4 (hollow) body
6 cavity
8 gas

1.-10. (canceled)

11. A securing element for a motor vehicle, comprising:
a hermetic body made of plastic which encloses a cavity, the plastic having a defined coefficient of thermal expansion;
a filling medium in the cavity, the filling medium having a defined coefficient of thermal expansion, wherein
the coefficient of thermal expansion of the filling medium, at least up to a softening temperature of the plastic, is greater than the coefficient of thermal expansion of the plastic.

12. The securing element according to claim 11, wherein the plastic is a polyamide.

13. The securing element according to claim 11, wherein the securing element is an additively manufactured securing element.

14. The securing element according to claim 13, wherein
the securing element is of a powder, wherein the hermetic body comprises the powder in completely remelted form, and wherein the filling medium comprises the powder in powder form and/or partially remelted form.

15. The securing element according to claim 14, wherein the powder is remelted or partially remelted via powder bed fusion.

16. The securing element according to claim 11, wherein the filling medium comprises at least one gas, at least one liquid, and/or at least one solid.

17. The securing element according to claim 16, wherein a proportion by volume of the at least one gas in the filling medium is 60 to 70 percent by volume of the total volume.

18. The securing element according to claim 11, further comprising:
at least one partition wall and/or at least one connecting web arranged in the cavity, wherein
a connecting web connects walls delimiting the cavity to one another, a wall delimiting the cavity to a partition wall, or two partition walls to one another.

19. The securing element according to claim 11, wherein the securing element is a mounting hook.

20. An assembly, comprising:
an interior mirror base of a motor vehicle; and
a cover for the interior mirror base of the motor vehicle, wherein
the cover includes a securing element comprising:
a hermetic body made of plastic which encloses a cavity, the plastic having a defined coefficient of thermal expansion;
a filling medium in the cavity, the filling medium having a defined coefficient of thermal expansion, wherein
the coefficient of thermal expansion of the filling medium, at least up to a softening temperature of the plastic, is greater than the coefficient of thermal expansion of the plastic.
